(19) United States
(12) Patent Application Publication
(10) Pub. No.: US 2009/0166137 A1
(43) Pub. Date: Jul. 2, 2009

(54) RETRACTED VANE ROTOR

(75) Inventors: Gang Lou, Rochester, MI (US); Keqin Xu, Windsor (CA); John Andrek, Fowlerville, MI (US); Richard Perry, Perry, MI (US); Brad Malott, Grand Haven, MI (US)

Correspondence Address: DOBRUSIN & THENNISCH PC, 29 W LAWRENCE ST, SUITE 210, PONTIAC, MI, 48342, US

(73) Assignee: Akebono Corporation (North America)

(21) Appl. No.: 12/166,391

(22) Filed: Jul. 2, 2008

Related U.S. Application Data
(63) Continuation-in-part of application No. 11/843,985, filed on Aug. 23, 2007.

(51) Int. Cl. F16D 65/12

(52) U.S. Cl. 188/218 XL

(57) ABSTRACT

The present invention is predicated upon a disc brake rotor, being made up of a rotor hat, a pair of spaced apart plates, and one or more vane members located between the first and second plates, the one or more vane members including an exterior wall portion inwardly retracted from an outer circumference by an exterior radial spacing and an interior wall portion outwardly retracted from the inner circumference by an interior radial spacing, wherein at least one of the exterior radial spacing and the interior radial spacing is a distance having a depth greater than about 5 mm for the purpose of reducing brake noise in a brake-on position.

### CLAIM OF PRIORITY

The present invention is a continuation-in-part that claims the benefit of the priority of the filing date of U.S. patent application Ser. No. 11/843,985 filed Aug. 23, 2007, which is herein incorporated by reference for all purposes.

### FIELD OF THE INVENTION

The present invention is predicated upon systems and methods for improving brake rotors and more specifically reduction of vibration and noise generated thereby during operation.

### BACKGROUND OF THE INVENTION

Brake vibration and resulting noise therefrom has long been a common problem for brake suppliers and vehicle manufacturers. This vibration and noise is a source of customer dissatisfaction resulting in warranty costs and loss of future sales. With respect to brake rotor systems, sliding contact between the pads and rotor during brake operation may excite the rotor to vibrate in various modes. These modes may be tangential (e.g. in-plane) or normal (e.g. out-of-plane) with respect to the friction surfaces of the rotor disc. These modes are mainly influenced by the rotor geometry, and to a lesser extent the surrounding components and suspension of the vehicle system. Historically manufacturers would modify this by changing the vane members for stiffness, the thickness of the plates or adding a dampening band.

For packaging and thermal performance, the geometry of the rotors, particularly the friction plates, is generally fixed. This invention thus pertains to designing the rotor to influence its response to excitation within the design limits imposed by packaging and thermal performance.

Examples of efforts in the art toward rotor design are found in U.S. Pat. Nos. 6,193,023; 6,454,958; and 6,655,508; which are herein incorporated by reference for all purposes.

### SUMMARY OF THE INVENTION

The present invention seeks to improve on prior brake systems and particularly vibration and noise thereof by providing an improved rotor design having retracted features located about the outer edges of at least one of the one or more vane members of the rotor disc. In one aspect, the present invention provides a machined brake rotor. In another aspect, the present invention provides a cast brake rotor. The rotor, whether machined or cast, includes a rotor hat, a pair of spaced apart plates, and one or more vane members located between the first and second plates. The spaced apart plates include a first plate attached with the rotor hat, the first plate including an outer wall and a second plate including an outer wall, and an inner wall portion defining an inner circumference. At least one of the outer walls of the first and second plates defines an outer circumference. The one or more vane members including an outer wall portion inwardly retracted from the outer circumference by an exterior radial spacing and an inner wall portion outwardly retracted from the inner circumference by an interior radial spacing. At least one of the exterior radial spacing and the interior radial spacing is a distance having a depth greater than about 5 mm.

In another aspect, the present invention contemplates a disc brake rotor, including a rotor hat, a pair of spaced apart plates, and a plurality of spaced apart vane members radially extending from an interior portion to an exterior portion of the rotor, the plurality of vane members located between the first and second plates. The pair of spaced apart plates includes a first plate attached with the rotor hat, the first plate including an outer wall and a second plate including an outer wall, and an inner wall portion defining an inner circumference. At least one of the outer walls of the first and second plates defines an outer circumference. The plurality of spaced apart vane members include an outer wall portion defining an exterior peripheral wall, the outer wall portion being inwardly retracted from the outer circumference by an exterior radial spacing and an inner wall portion defining an interior peripheral wall, the inner wall portion being outwardly retracted from the inner circumference by an interior radial spacing. At least one of the exterior radial spacing and the interior radial spacing is a distance having a depth from about 7 to about 15 mm.

In another aspect, the present invention contemplates a disc brake rotor, including a rotor hat, a pair of spaced apart plates, and a plurality of spaced apart vane members radially extending from an interior portion to an exterior portion of the rotor, the plurality of vane members located between the first and second plates. The pair of spaced apart plates including a first plate attached with the rotor hat, the first plate including an outer wall and a second plate including an outer wall, and an inner wall portion defining an inner circumference. At least one of the outer walls of the first and second plates defines an outer circumference. The plurality of vane members including an outer wall portion defining an exterior peripheral wall, the outer wall portion being inwardly retracted from the outer circumference by an exterior radial spacing and an inner wall portion defining an interior peripheral wall, the inner wall portion being outwardly retracted from the inner circumference by an interior radial spacing. The exterior radial spacing and the interior radial spacing are a distance having a depth from about 7 to about 15 mm. Brake noise greater than about 70 dB has a rate of occurrence less than about 25%.

In yet another aspect, any of the aspects of the present invention may be further characterized by one or any combination of the following features the ratio of (i) the exterior radial spacing to the diameter of the rotor, (ii) the interior radial spacing to the diameter of the rotor, or (iii) both (i) and (ii) is from about 1:80 to about 1:10; the exterior radial spacing is a distance having a depth greater than 10 mm; at least one of the exterior radial spacing and the interior radial spacing is distance having a depth from about 7 to about 15 mm; brake noise greater than about 70 dB has a rate of occurrence less than about 25%; both the exterior radial spacing and the interior radial spacing are a distance having a depth greater than about 5 mm; the exterior radial spacing and the interior radial spacing are generally a distance having a depth that is the same or different; at least one of the outer wall portion and the inner wall portion is generally a flat surface or an arcuate surface; the exterior radial spacing is a distance having a depth from about 10 about 15 mm and the interior radial spacing is a distance having a depth less than about 5 mm; at least one of the exterior peripheral wall and the interior peripheral wall is separated so as to define at least one groove having two opposing wall portions of equal thickness or of different thickness; at least one groove has a profile relative to one of exterior and interior peripheral walls including a portion that is characterized by a flat side wall, an arcuate side wall, a flat bottom, an arcuate bottom, a portion substantially resembling a U-shape, a portion substantially resembling a V-shape, or any combination thereof.

It should be appreciated that the above referenced aspects and examples are non-limiting as others exist within the present invention, as shown and described herein.

### BRIEF DESCRIPTION OF THE DRAWINGS

FIG. 1 illustrates a side view of an illustrative example of the present invention.

FIG. 2 illustrates a side view of an illustrative example of standard single disc plate disc brake rotor, unmodified according to the present invention.

FIG. 3 illustrates a side view of a second illustrative example of the present invention.

FIG. 4 illustrates a side view of a multiple illustrative examples of the groove profiles of the present invention.

FIGS. 5 through 8 are graphical representations of exemplary expected frequency results of one illustrative example of the present invention.

FIG. 9 illustrates a side view of a typical illustrative example.

FIGS. 10a through 10c illustrate a side view of multiple illustrative examples of the retracted configurations of the present invention.

FIGS. 11a through 11f illustrate a side view of multiple illustrative examples of the retracted configurations with groove segments.

FIGS. 12 and 13 are graphical representations of exemplary expected noise output of several illustrative examples of the present invention.

### DETAILED DESCRIPTION

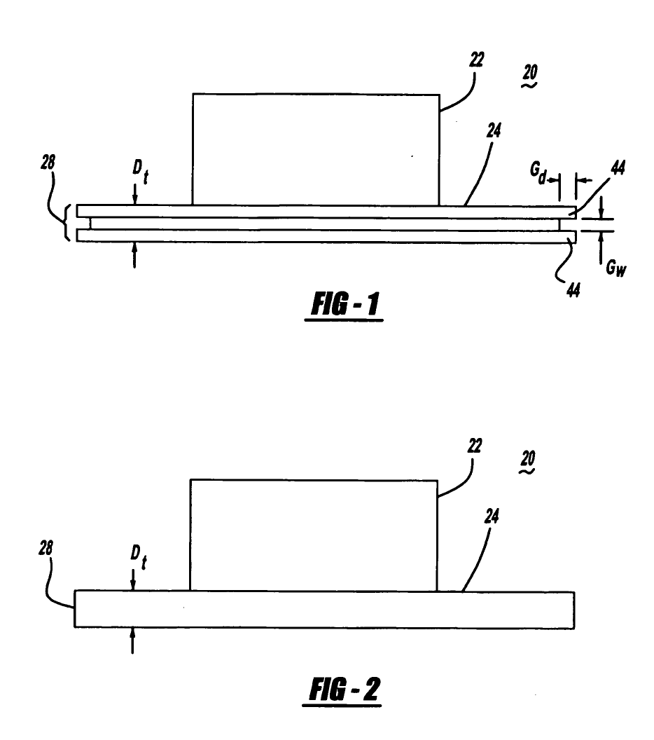

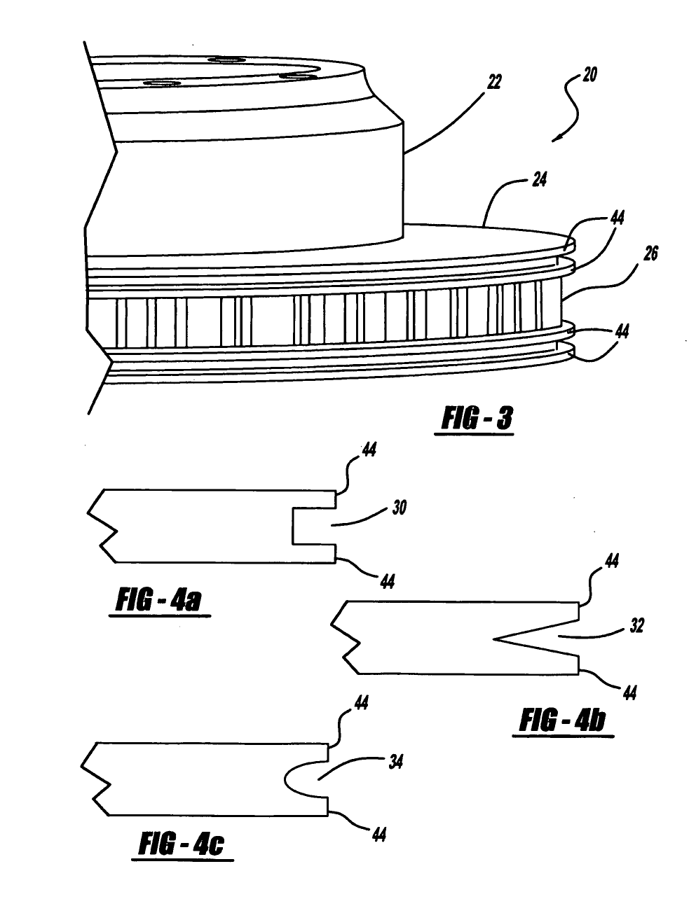

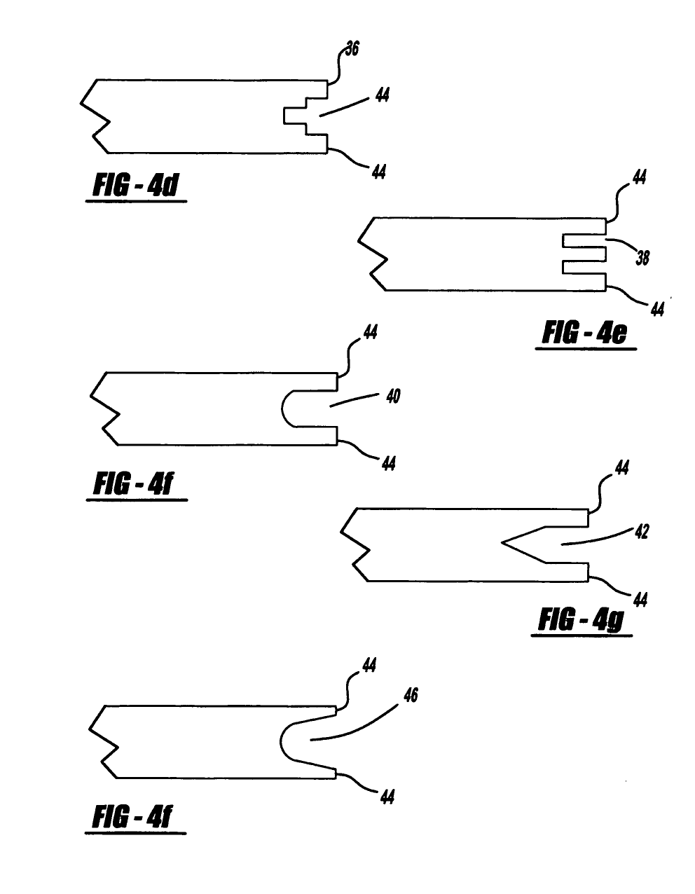

The present invention is directed at an improved disc brake rotor 20 particularly one that includes a rotor hat 22 and at least one disc 24 (e.g., plate) as seen in FIGS. 1-3 (with and without the groove feature respectively). The disc may include or even consist essentially of a single disc plate, as shown on the disc 24 of FIG. 2. It may also include a plurality of spaced apart disc plates, as in FIGS. 3 and 10a-11e, which shows plates separated by a plurality of vane members 26 (e.g., fins) that may have a retracted configuration with and without the groove feature, respectively. The present invention seeks to improve on prior brake systems and particularly to change the natural frequency of the rotor so that it will fall within a predetermined target frequency. More particularly, the present invention seeks to substantially reduce or eliminate brake noises (e.g., squeal). Each natural frequency has an associated vibration mode shape, these mode shapes may be tangential (e.g. in-plane) or normal (e.g. out-of-plane) with respect to the friction surfaces of the disc 24. This is accomplished by providing an improved rotor design having groove features located about the outer edge of the rotor disc and/or about the vane members between the two rotor discs. Desirably, this may further be accomplished without the need to add a separate dampening band, or dampening insert, as in Published U.S. application No. 2006/0076200. Thus, in service, the grooves of the invention herein are unfilled. Additionally, this is accomplished while substantially avoiding rotor fatigue, maintaining acceptable rotor stiffness and increasing the heat dissipation potential of the rotor through increased surface area.

It is contemplated that the disc 24 may consist essentially of a single solid disc or plate, as seen in FIGS. 1-2, or it may include at least a pair of spaced apart plates connected by a plurality of vane members 26 as seen in FIGS. 3 and 9-11e. Each plate 24, whether used in a disc with single plate or a multiple plate/vane construction, may have an overall thickness of at least about 3.0 to 20.0 mm and will include a peripheral wall 28.

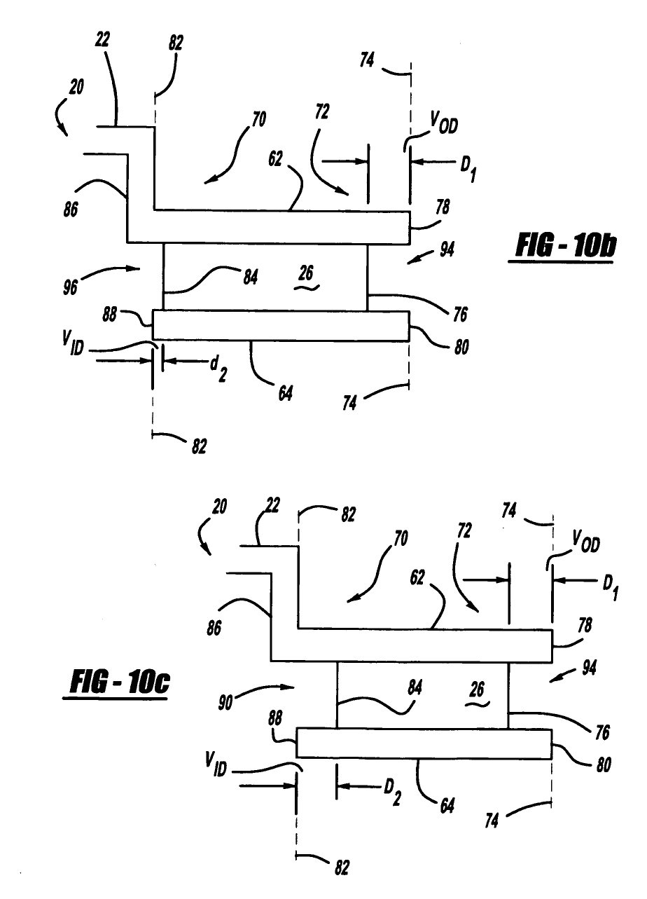

With reference to FIG. 3, by way of general background, one example rotor 20 of a disk brake is shown. As can be seen in FIG. 3, the first and second friction plate may be joined together through one or more vane members 26. In this configuration, air can travel between the friction plates, e.g. via a substantially continuous and relatively uninterrupted flow path and stiffening members to provide cooling thereof. Accordingly, it is contemplated that the air can move from an interior portion 70 of the first or second friction plate to an exterior portion 72. With reference to FIG. 9, one example cross-section of a rotor 20 of a disc brake is illustrated. The rotor includes a pair of plates 24 having a first friction plate 62 and a second friction plate 64. The first, the second, or both friction plates are further attached to a rotor hat 22 (e.g., flange portion) for mounting to an axle portion of a vehicle.

In one aspect, it is contemplated that the peripheral wall(s) 28 of the plate(s) 24 may have a generally flat profile about the 360° disc arc except in at least one predefined arc segment wherein there is at least one groove configuration defined therein. For embodiments that include plural plates separated by vane members, on multiple plate/vane constructions, it is contemplated that at least one if not more than one of the plates 24 may have at least one peripheral groove defined in at least one of the plates, though not required.

Generally, it is contemplated that a particular groove configuration is disposed about the peripheral wall in one or more multiple discrete groove segments. The configuration may span the entirety of the peripheral wall, or only a portion. For example, separated by arc segments with a flat profile (e.g. defined by the peripheral wall), a different groove configuration, or any combination thereof. In one embodiment, there may be at least two groove arc segments, spaced about angularly equidistant from each other along the disc arc, and which extends for at least about 7.5° of the 360° arc each. In another embodiment, there may be at least three groove arc segments, spaced about angularly equidistant from each other along the disc arc, and which extends at least about 5.0° of the 360° arc each. Whether the groove segment is contained in a single area or in multiple areas (e.g. two, three or more areas) along the disc arc, it is preferable that the total grooved arc segment or segments extend at least about 15° of the 360° arc, more preferably at least about 30° of the 360° arc, and most preferably at least about 60° of the 360° arc. In some instances, it is contemplated that the grooved arc segment may be located around the complete 360° of the peripheral wall 28 of the plate 24. Though it is possible the arc segments are less than about 270°, less than about 180°, or even less than about 90° of a 360° arc. Furthermore, it is possible that the arc segments are greater than about 5°, greater than about 15°, or even greater than about 60° of the 360° arc. For example, it is possible that the arc segments range from about 5° to about 270°, from about 15° to about 180°, or even from about 60° to about 90° of the 360° arc.

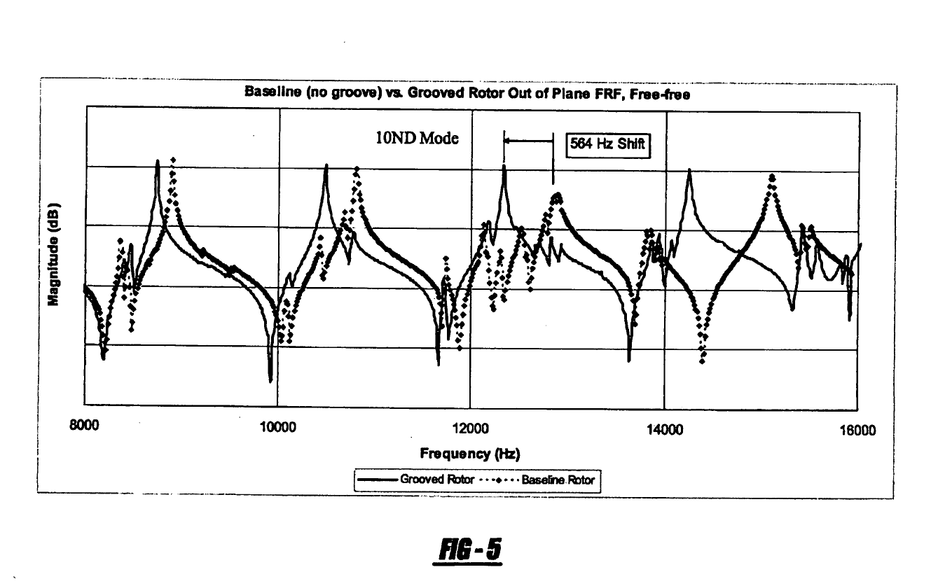

Various groove configurations and locations within the peripheral wall 28 of the plate 24 may be employed. The profile of the groove can be a variety of differing shapes and sizes. As illustrative examples, in FIG. 4, the groove can have a square groove profile 30, a triangular profile 32, a rounded profile 34, a stepped profile 36, multiple grooves 38 with similar or differing profiles, or any combination thereof. The profile relative to the peripheral wall 28 can also include a portion with a flat side wall, an arcuate side wall, a flat bottom, an arcuate bottom, a portion substantially resembling a U-shape 40, a portion substantially resembling a V-shape 42, or any combination thereof.

The depth of the groove G_{d}, is measured from the outer edge of the peripheral wall moving towards the rotational axis of the disc to its deepest point. The preferable depth ranges from about 2.0 to 10.0 mm, more preferably from about 2.5 to 7.0 mm and even more preferably from about 3.0 to about 6.0 mm.

Depth of at least one of the grooves can also be calculable based upon the thickness of the plate 24. For the present invention, it is believed that the greater the depth, the higher the natural frequency shift. Although, a groove that is too deep can potentially cause undesirable stress and fatigue issues. In a preferred embodiment, the ratio of the disc thickness Dₜ to the depth of at least one groove is from about 1.5:1 to 10:1, even more preferably a ratio from about 1.75:1 to 5:1, and most preferably from about 2:1 to 3:1.

The width of the groove G_{w}, is measured as the maximum width of a given groove profile. The invention contemplates that the smaller the width of the groove, along with an appropriate groove depth, the higher potential for frequency separation and a higher stiffness response. The preferable width ranges from about 1.0 to 7.0 mm, more preferably from about 1.25 to 5.0 mm and even more preferably from about 1.5 to 4.0 mm. It is understood that these preferred ranges can vary as the overall thickness of the plate 24 vary from differing disc brake rotor designs.

It is contemplated that the location of the groove, relative to the side walls of the plate 24 can be varied according to the needs of the overall disc brake system. In one embodiment, the groove can be placed generally near the middle of the peripheral wall 28, thereby separating the disc plate periphery into opposing wall portions 44 of nearly equal thickness with a solid center portion (e.g. where the groove is disposed) in-between. In another embodiment, the groove is offset from the center in the peripheral wall 28, thus producing opposing wall portions 44 of differing thickness (e.g. a first opposing wall portion having one thickness and a second opposing wall portion having a second thickness). This differing opposing wall thickness can also be accomplished by using any number of asymmetrical groove profiles, specifically where the asymmetry is calculated about the centerline of the given groove profile, for example as seen in FIG. 4h.

In one preferred embodiment, the disc or plate 24 includes at least one groove configuration with a predetermined groove profile that is sufficient for a relative movement of an out of plane rotor mode frequency versus an in-plane rotor mode frequency by at least about 4%, while substantially avoiding rotor fatigue.

In another preferred embodiment, the disc brake rotor is a unitary structure that is cast to a near net shape including a predetermined groove profile located in the plate's peripheral wall. Subsequent post-casting processing may or may not be required.

In yet another preferred embodiment, the disc brake rotor is machined from separate metallic stock pieces and assembled into a complete disc brake rotor, wherein the groove feature is formed by machining the groove profile into the plate 24 or plates which form the disc.

In yet a further preferred embodiment, the disc brake rotor is constructed from a combination of machined and cast pieces and the groove feature can be formed by casting, machining, or any combination of these processes.

In an illustrative example, shown in FIG. 1, a generally rectangular groove profile is included in the peripheral wall 28 of a single plate cast iron brake rotor. The groove profile has a groove depth G_{d} of about 5.0 mm and a groove width G_{w} of about 4.0 mm. The groove is located about the center of the peripheral wall 28 and its grooved arc segment circumscribes the entire plate 24.

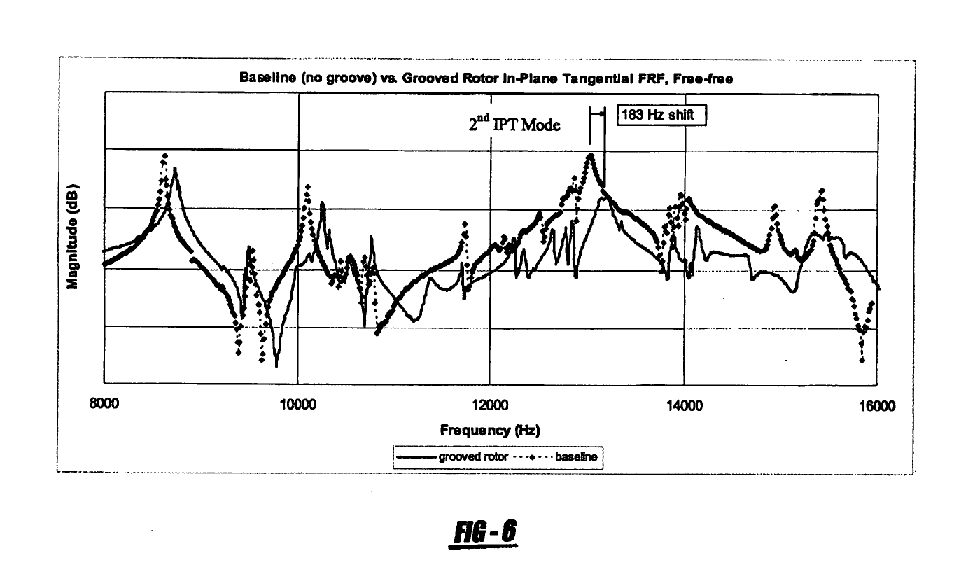

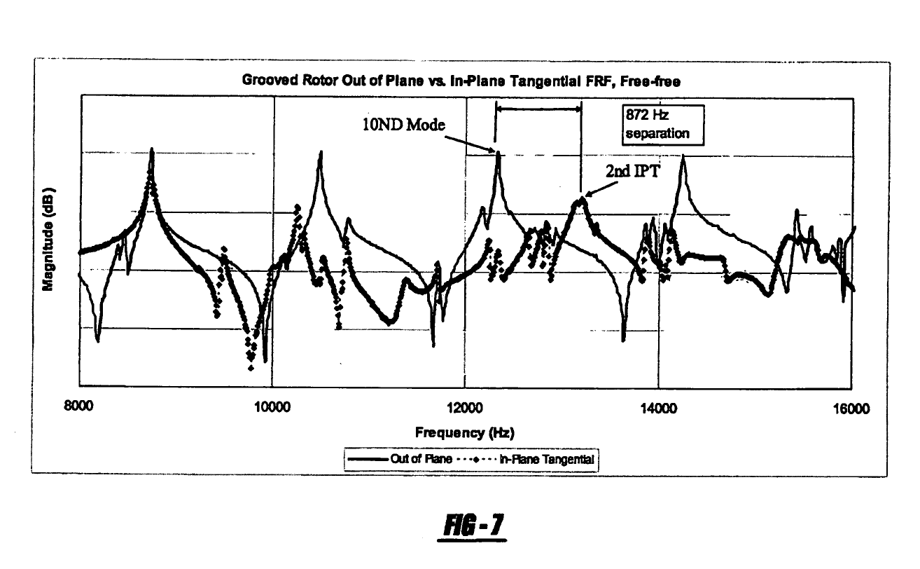

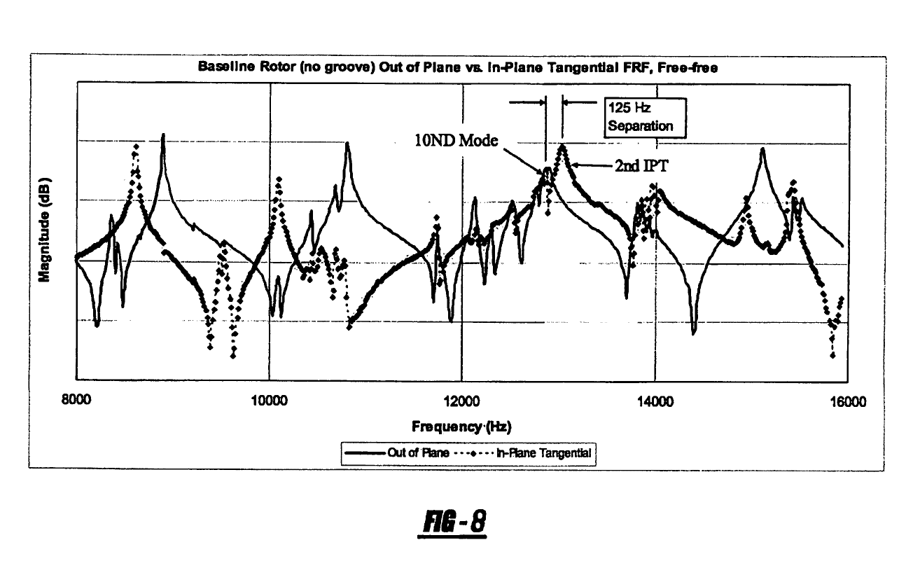

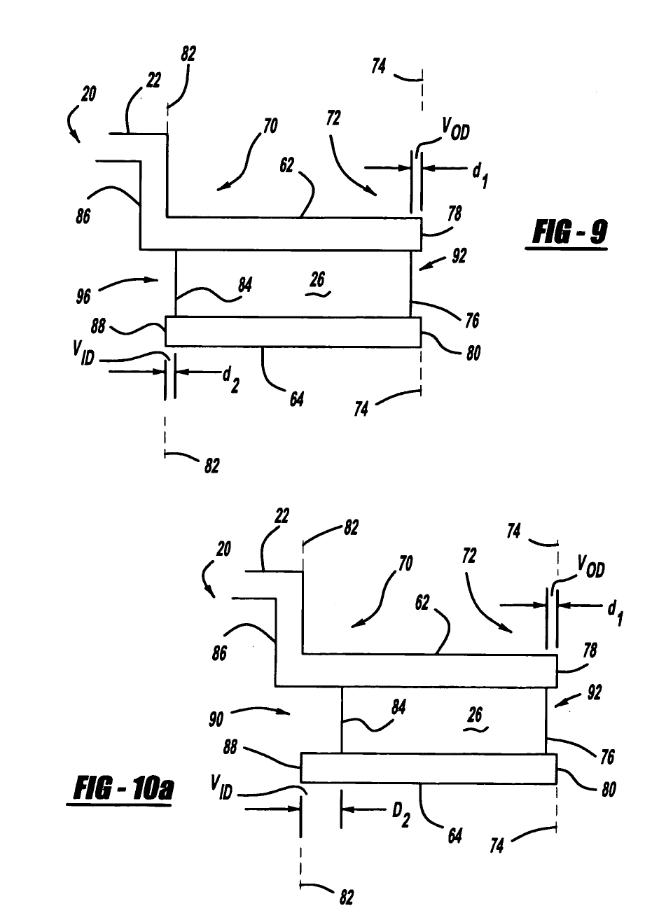

In this same example the frequency response functions (“FRF”) in both the out of plane and in-plane directions are measured prior to the addition of the groove feature and are shown as the “baseline rotor” line in FIGS. 5, 6, 7 and 8. The groove profile is added to the rotor plate and the frequencies are measured again, shown as the “grooved rotor” line in FIGS. 5, 6, and 7. The frequency shift for the out of plane mode (The 10^{th} nodal diametrical mode, labeled as 10ND rotor mode), referring to FIG. 5, is about 564 Hz and the frequency shift for the 2^{nd} in-plane mode (labeled 2^{nd} IPT mode), referring to FIG. 6, is about 183 Hz. Referring to FIG. 7, the in-plane versus the out of plane modes show about an 872 Hz separation, which represents an increase in separation of the two respective modes of about of 750 Hz or about seven times that of the baseline rotor, baseline shown in FIG. 8.

For the present invention, and illustrated in the above example, it is believed that the addition of the groove feature generally decreases the out of plane rotor mode frequency while increasing the in plane rotor mode frequency, thus creating one desirous effect of a larger separation between the respective frequency modes. A separation of up to ten times greater or more than compared with a rotor without the present invention. Another desirous effect that is contemplated by the present invention is achieving a smaller separation between the respective frequency modes by use of the groove feature.

Without intending to be bound by theory, it is believed that certain of the noise that is overcome by the present invention is due to a vibration that results from a plurality of frequencies (e.g., at least a first frequency and a second frequency) arising from one or more deformation modes of the rotor 20. The invention thus contemplates a method for designing an automotive vehicle brake for reducing noise contributed by a brake rotor of an automotive vehicle, comprising the steps of identifying at least a first and a second frequency in at least one deformation mode for a rotor having a rotational axis and selectively introducing a groove feature (as taught herein) to the peripheral wall 28 of the plate 24 for achieving frequency shift of at least about 4%.

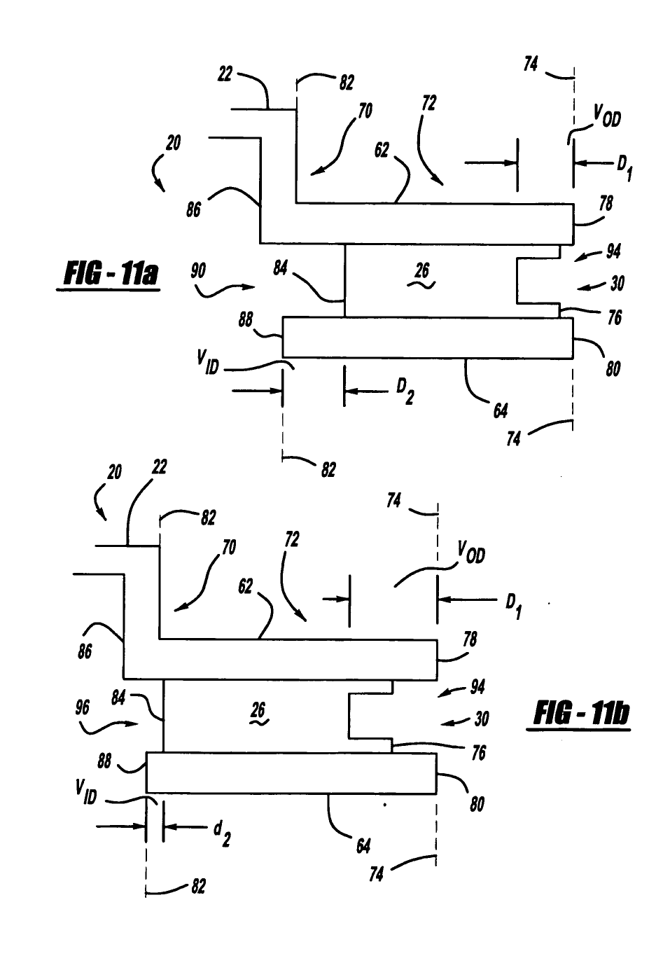

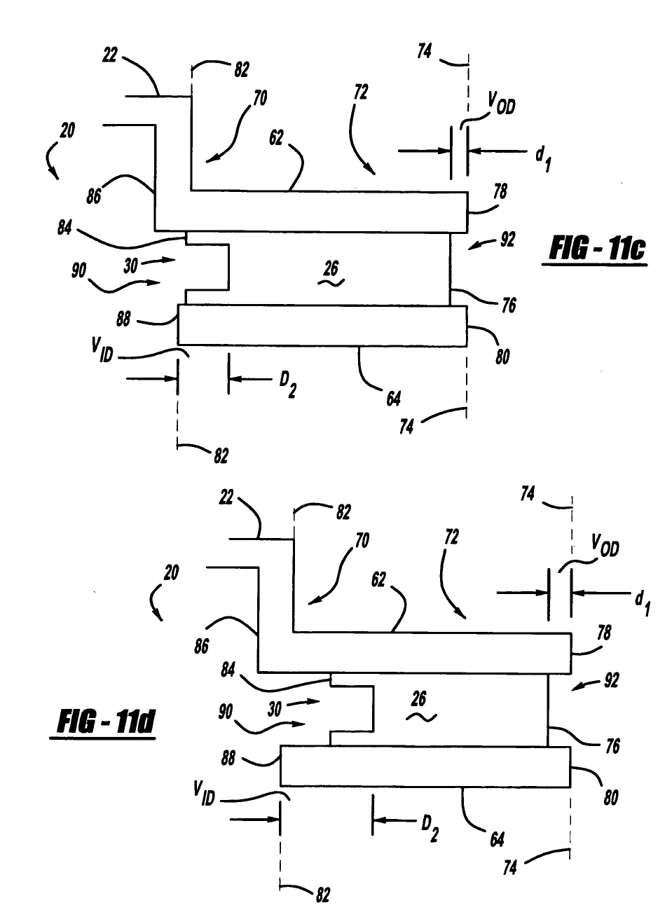

In another aspect, it is contemplated that a particular retracted vane configuration may be desirable, and thus the present invention is further directed to a disc brake rotor having a retracted vane configuration. The disc brake may accordingly include a rotor hat, a pair of spaced apart discs, and one or more vane members located between the first and second discs. The pair of spaced apart discs may include a first disc and a second disc. The first disc having an outer wall portion and an inner wall portion attached with the rotor hat. The second disc may include an outer wall portion and an inner wall portion. The inner wall portion of the second plate being configured to define an inner circumference. At least one of the outer walls of the first and second discs may be configured to define an outer circumference. The one or more vane members preferably include an interior wall portion outwardly retracted from the inner circumference, and an exterior wall portion inwardly retracted from the outer circumference. The interior wall portion, the exterior wall portion, or both are retracted relative to the interior circumference and the exterior circumference, respectively, by a depth greater than 5 mm so as to define at least one retracted vane configuration. For example, the respective ends (e.g., the exterior wall portion and the interior wall portion) of the one or more vane members may be offset relative to the outer circumference and/or the inner circumference, respectively. In one approach, it is appreciated that the retracted vane configuration may be utilized in addition to or as an alternative to the groove configuration of the plate(s) as discussed above. In another approach, it is appreciated that the one or more vane members may include the retracted vane configuration, the groove feature, or a combination of both so as to substantially reduce or eliminate brake noise. Various examples are provided in accordance with the drawings of FIGS. 10a through 11f.

Various retracted vane configurations and locations within the outer circumference 74, the inner circumference 82, or combinations of both may be employed. A portion of the vane member (e.g., an exterior wall portion 76 and/or an interior wall portion 84) may be radially spaced (e.g., retracted, displaced, offset, or otherwise) relative to the outer and inner circumferences 74, 82, respectively. The exterior wall portion 76, the interior wall portion 84, or both may be generally a flat surface, an arcuate surface, or otherwise. In one specific example, the exterior wall portion 76, the interior wall portion 84, or both may include a groove, as discussed herein, an aperture portion extending outward of the vane member (not shown), or otherwise. It is contemplated that one or more vane members may include a retracted vane configuration, a groove feature, or both while one or more vane members of the same rotor may not have a retracted vane configuration, a groove feature, or a combination of both. The radial spacing in the exterior portion 72 of the rotor may be defined by an exterior vane depth (e.g., exterior radial spacing) V_{OD}. The radial spacing in the interior portion 70 of the rotor may be defined by an interior vane depth (e.g., interior radial spacing) V_{ID}. It is further contemplated that when included the radial spacing (e.g., of the retracted vane configuration and/or the groove feature) may be different from one vane member to another vane member so as to be non-universal (e.g., different retraction depths for various vane members) or may be the same so as to be universal in all vane members. For example, all or some of the exterior portions of the vane members may have the same or different exterior radial spacing, all or some of the interior portions of the vane members may have the same or different interior radial spacing, or all or some of both the exterior and interior portions of the vane members may have the same or different radial spacing.

For example, in one vane configuration, the exterior radial spacing V_{OD} may be measured from the outer circumference 74 to the deepest segment of the exterior wall portion 76 of the vane member 26 as depicted in FIGS. 10a through 11f. The outer circumference 74 may be generally defined by at least one of the outer wall portions 78, 80 of the first and second plates 62, 64, respectively. In one embodiment, it is appreciated that the outer wall portions 78, 80 may be generally the same radial distance from the rotational axis Ra such that the outer circumference 74 may be defined by both outer wall portions 78, 80, though not required. However, it is further appreciated in another embodiment that the outer wall portions 78, 80 may have different radial distances from the rotational axis Ra such that the outer circumference 74 may be taken from the respective outer wall portion of the plate with the smaller radial distance from the rotational axis Ra, the respective outer wall of the plate that may be more proximate to the exterior wall portion 76 of the vane member 26, or a combination of both.

In another vane configuration, the interior radial spacing V_{ID} may be measured from the inner circumference 82 to the deepest segment of the interior wall portion 84 of the vane member 26. The inner circumference 82 may be generally defined by at least one of the inner wall portions 86, 88 of the first and second plates 62, 64, respectively. It is appreciated in one embodiment that the inner wall portions 86, 88 may be generally the same radial distance from the rotational axis Ra such that the inner circumference 82 may be defined by both inner wall portions 86, 88, though not required. However, it is further appreciated in another embodiment that the inner wall portions 86, 88 may have different radial distances from the rotational axis Ra such that the inner circumference 82 may be taken from the respective inner wall of the plate with the larger radial distance from the rotational axis Ra, the respective inner wall of the plate that may be more proximate to the interior wall portion 84 of the vane member 26, or a combination of both.

Preferably, the outer circumference 74 may be generally taken from both the outer wall portions 78, 80 of the first and second plates 62, 64, respectively, which are generally located the about same radial distance from the rotational axis Ra. Furthermore, the inner circumference 82 may be generally taken from the inner wall portion 88 of the second plate 64, which is generally located more proximate to the interior wall portion 84 of the vane member 26 than the inner wall portion 86 of the first plate 62.

Without being bound by theory, it is believed that the typical radial spacing(s) of the vane member 26 as provided in FIG. 10 define a typical exterior radial spacing V_{OD} of a typical distance d1 (e.g., about 2 mm) and a typical interior radial spacing V_{ID} of a typical distance d2 (e.g., about 2 mm), which produce undesirable amounts of brake noise during a brake-on position (e.g., engagement of the brakes). As such, the present invention is directed to the geometry, orientation, and placement of the vane members 26. In another particular aspect, according to the present invention, the vane members 26 are provided in a retracted vane configuration that includes an increase in radial spacing from the outer circumference 74, the inner circumference 82, or a combination of both to at least one of the exterior and interior wall portion 76, 84, of the vane member 26 as compared with a rotor structure that does not include such retracted vane configuration (FIG. 9). In yet another particular aspect, according to the present invention, the retracted vane configuration may further include the groove feature that incorporates a groove profile (e.g., 30, 32, 34, 36, 38, 40, 42, 46, or otherwise) within a segment of the respective exterior or interior wall portion 76, 84 of the vane member 26. As such, the various aspects of the present invention that are discussed herein are advantageously provided so as to substantially reduce or eliminate brake noise during a brake-on position.

By way of illustration, referring to FIGS. 10a through 10c, exemplary configurations of retracted vane members are shown. In each example shown, the retracted vane member includes at least one radially spaced (e.g., retracted, displaced, offset, or otherwise) wall portion (e.g., exterior wall portion 76, interior wall portion 84). For example, the exterior wall portion 76 may be radially spaced with respect to the outer circumference 74 to define a retracted exterior radial spacing V_{OD} of a retracted distance D1, the interior wall portion 84 may be radially spaced from the inner circumference 82 to define a retracted interior radial spacing V_{ID} of a retracted distance D2, or a combination of both. The retracted radial spacing may be a distance (e.g., D1, D2) of at least about 5 mm, and preferably at least about 7 mm. Furthermore, the retracted radial spacing may be a distance less than about 20 mm, and preferably less than about 15 mm. For example, the retracted radial spacing may be a distance between about 5 mm and about 20 mm, and preferably between about 7 mm and about 15 mm.

Similarly to the discussion above, the distance (e.g., depth, retraction, or otherwise) of at least one of the exterior and interior radial spacings V_{OD}, V_{ID}, respectively can also be calculable based upon the diameter, the thickness, or otherwise of one or both of the first and second plates 62, 64. For the present invention, it is believed that the greater the radial spacing (e.g., retraction), the larger the reduction of brake noise. Although, radial spacing that is too deep can potentially cause undesirable stress and fatigue issues. In a preferred embodiment, the ratio of the exterior radial spacing V_{OD} (e.g., d1, D1) to the diameter of the rotor 20 may be from about 1:80 to about 1:10, and preferably a ratio from about 1:60 to about 1:20. In another preferred embodiment, the ratio of the interior radial spacing V_{ID} (e.g., d2, D2) to the diameter of the rotor 20 may be from about 1:80 to about 1:10, and preferably a ratio from about 1:60 to about 1:20.

In another preferred embodiment, as shown in FIG. 10a, the rotor 20 includes the first and second plates 62, 64 and vane member 26 having an interior retracted vane configuration 90, therebetween. The vane member 26 may be radially spaced such that the interior wall portion 84 is outwardly retracted in the interior portion 70 of the rotor 20 thereby providing a retracted interior radial spacing V_{ID} having a retracted distance in an amount of D2. The exterior wall portion 76 may be positioned in a typical exterior vane configuration 92 thereby providing a typical exterior radial spacing V_{OD} having a typical distance in the amount of d1. In this embodiment, it is appreciated that the retracted interior radial spacing V_{ID} of D2 is greater than the typical exterior radial spacing V_{OD} of d1 (e.g., the retracted interior radial spacing V_{ID} of D2 may be at least twice the distance of the typical exterior radial spacing V_{OD} of d1).

In another preferred embodiment, as shown in FIG. 10b, the rotor 20 includes the first and second plates 62, 64 and the vane member 26 having an exterior retracted vane configuration 94, therebetween. The vane member 26 may be radially spaced such that the exterior wall portion 76 is inwardly retracted in the exterior portion 72 of the rotor 20 thereby providing a retracted exterior radial spacing V_{OD} having a retracted distance in an amount of D1. The interior wall portion 84 may be positioned in a typical interior vane configuration 96 so as to provide a typical interior radial spacing V_{ID} having a typical distance in the amount of d2. In this embodiment, it is appreciated that the retracted exterior radial spacing V_{OD} of D1 is greater than the typical interior radial spacing V_{ID} of d2 (e.g., the retracted exterior radial spacing V_{OD} of D1 may be at least twice the distance of the typical interior radial spacing V_{ID} of d2).

In yet another preferred embodiment, as shown in FIG. 10c, the rotor 20 includes the first and second plates 62, 64 and the vane member 26 has an interior retracted vane configuration 90 and an exterior retracted vane configuration 94, therebetween. The vane member 26 may be radially spaced such that the interior wall portion 84 is outwardly retracted in the interior portion 70 of the rotor 20 thereby providing a retracted interior radial spacing V_{ID} having a retracted distance in an amount of D2. Desirably, the vane member may also be radially spaced such that the exterior wall portion 76 is inwardly retracted in the exterior portion 72 of the rotor 20 thereby providing a retracted exterior radial spacing V_{OD} having a retracted distance in an amount of D1. In this embodiment, it is appreciated that both the retracted interior radial spacing V_{ID} of D2 and the retracted exterior radial spacing V_{OD} of D1 are greater than at least about 5 mm. It is further appreciated that the retracted interior radial spacing V_{ID} of D2 and the retracted exterior radial spacing V_{OD} of D1 may be a distance that is the same or different.

It is further contemplated that at least one exposed surface wall portion (e.g., 76, 84) of the vane member 26 may include a groove feature as discussed above. When included, one or more vane members may each have at least one groove that may be the same or different. As illustrated in FIGS. 10a through 10c, the vane members 26 are shown having a generally square or rectangular profile, though not required. As such, it is appreciated that various retracted vane configurations and locations within the vane member may be employed such that the profile of the vane member can be a variety of differing shapes and sizes. More particularly, the vane member 26 may include a retracted vane configuration further including an arcuate (e.g., convex or concave) or otherwise exposed surface wall portion 76, 84. The vane member 26 may further include a groove such that at least one of the exterior and interior wall portions 76, 84 may be configured with a groove profile similar to the examples shown in FIGS. 4a through 4h, or otherwise. By way of one specific groove profile as shown in FIGS. 11a through 11f, the present invention further provides several examples of vane members 26 utilizing a retracted vane configuration with optionally a groove (e.g., a square groove, or otherwise) profile 30 for substantially reducing or eliminating brake noise.

In one exemplary embodiment, FIG. 11a shows the vane member 26 including an interior retracted vane configuration 90 having a retracted interior radial spacing V_{ID} of D2 and an exterior retracted vane configuration 94 with a square groove profile 30 having a retracted exterior radial spacing V_{OD} of D1. The retracted exterior radial spacing V_{OD} of D1 may be measured from the deepest point of the square groove profile 30 to the outer circumference 74 as discussed above. The retracted interior radial spacing V_{ID} of D2 and the retracted exterior radial spacing V_{OD} of D1 may be the same or different and are a distance of at least about 5 mm.

In another exemplary embodiment, FIG. 11b shows the vane member 26 including a typical interior vane configuration 96 having a typical interior radial spacing V_{ID} of d2 and an exterior retracted vane configuration 94 with a square groove profile 30 a retracted exterior radial spacing V_{OD} of D1. The retracted exterior radial spacing V_{OD} of D1 may be a distance greater than the typical interior radial spacing V_{ID} of d2 (e.g., the retracted exterior radial spacing V_{OD} of D1 may be at least twice the distance of the typical interior radial spacing V_{ID} of d2).

In another exemplary embodiment, FIG. 11c shows the vane member 26 including an interior retracted vane configuration 90 with a square groove profile 30 having a retracted interior radial spacing V_{ID} of D2 and a typical exterior vane configuration 92 having a typical exterior radial spacing V_{OD} of d1. The retracted interior radial spacing V_{ID} of D2 has a distance greater than the typical exterior radial spacing V_{OD} of d1 (e.g., the retracted interior radial spacing V_{ID} of D2 may be at least twice the distance of the typical exterior radial spacing V_{OD} of d1).

In another exemplary embodiment, FIG. 11d shows the vane member 26 including an interior retracted vane configuration 90 with a square groove profile 30 having a retracted interior radial spacing V_{ID} of D2 and a typical exterior vane configuration 92 having a typical exterior radial spacing V_{OD} of d1. The retracted interior radial spacing V_{ID} of D2 having a distance greater than the typical exterior radial spacing V_{OD} of d1 (e.g., the retracted interior radial spacing V_{ID} of D2 may be at least twice the distance of the typical exterior radial spacing V_{OD} of d1).

In another exemplary embodiment, FIG. 11e shows the vane member 26 including an interior retracted vane configuration 90 with a square groove profile 30 having a retracted interior radial spacing V_{ID} of D2 and an exterior retracted vane configuration 94 with a square groove profile 30 having a retracted exterior radial spacing V_{OD} of D1. The retracted interior radial spacing V_{ID} of D2 and the retracted exterior radial spacing V_{OD} of D1 may be the same or different and are a distance of at least about 5 mm.

In another exemplary embodiment, FIG. 11f shows the vane member 26 including an interior retracted vane configuration 90 with a square groove profile 30 having a retracted interior radial spacing V_{ID} of D2 and an exterior retracted vane configuration 94 with a square groove profile 30 having a retracted exterior radial spacing V_{OD} of D1. The retracted interior radial spacing V_{ID} of D2 and the retracted exterior radial spacing V_{OD} of D1 may be the same or different and are a distance of at least about 5 mm.

It is appreciated that the above examples are not limiting and that additional configurations are possible. Furthermore, it is appreciated that the vane member having a retracted vane configuration with or without the groove feature may be configured to define a radial spacing(s) that may be varied for different braking environments so as to achieve the desired reduction or elimination of brake noise in a brake-on position in a given brake design relative to the braking environment.

In one specific illustrative example, similar to FIG. 10b, a generally rectangular vane member may be positioned between the outer circumference 74 and the inner circumference 82 of a multiple plate brake rotor. The outer wall portion 76 may be positioned in the exterior retracted vane configuration 94 having generally a flat surface, though not required, that may be inwardly displaced from the outer circumference 74 by a retracted exterior radial spacing V_{OD} having a retracted distance (e.g., D1) of about 12.0 mm, though possibly more (e.g., about 15.0 mm). The interior wall portion 84 may be positioned in the typical interior vane configuration 96 having a generally flat surface, though not required, that may be outwardly displaced from the inner circumference 82 by a typical interior radial spacing V_{ID} having a typical distance (e.g., the distance d2) of about 2.0 mm. The exterior retracted vane configuration may be similar throughout the plurality of spaced apart radially extending vane members of the rotor, though not required. This retracted vane member configuration was compared to a typical vane member configuration (e.g., similar to FIG. 9) having a V_{OD} of d1 about 2.0 mm and a V_{ID} of d2 about 2.0 mm for noise during a brake-on position. The rotor having a typical vane member configuration obtained a high level (e.g., as high as about 127 dB) noise of 2.4 kHz at typical operating conditions. The rotor having the retracted vane member configuration obtained substantially reduced brake noise (e.g., substantially or completely no brake squeal).

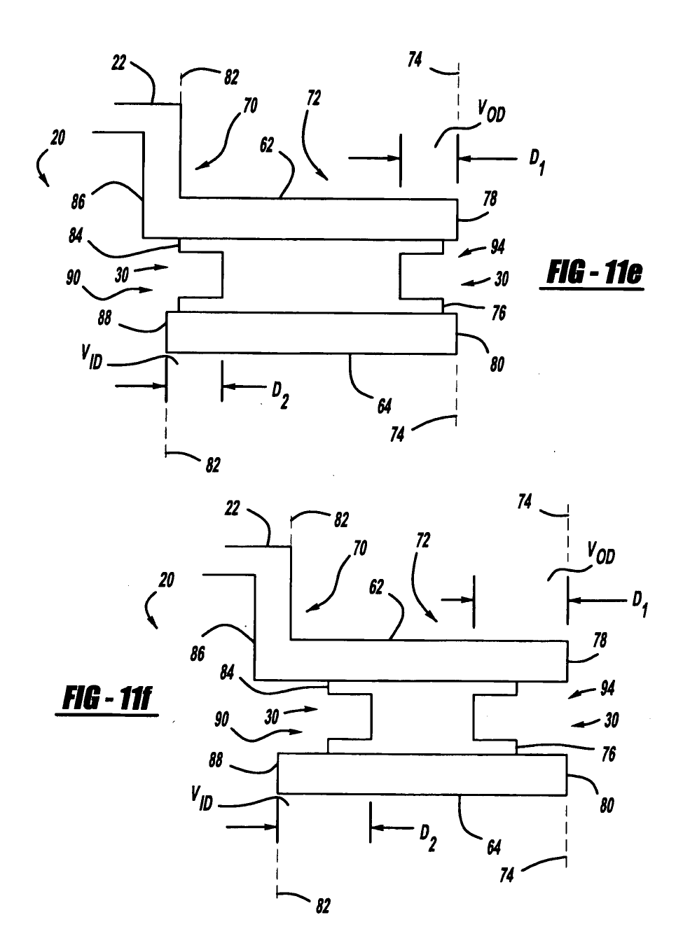

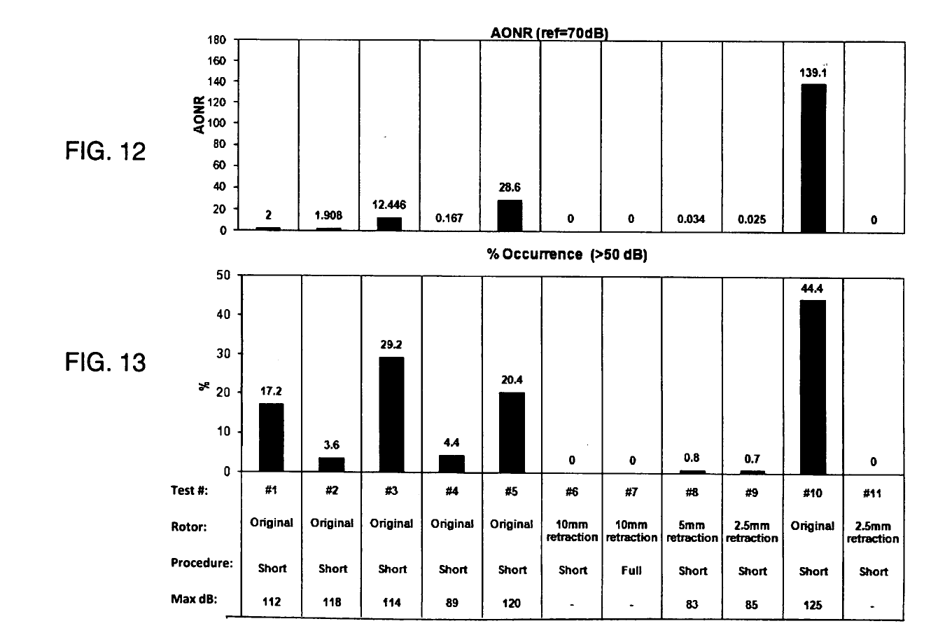

More particularly, in similar examples the noise occurrence rating (“ANOR”) in rotors having the exterior retracted vane member configuration 94 (e.g., similar to FIG. 10b) such that the outer wall portion 76 of the vane member will include about 10 mm retraction (e.g., a radial spacing of about 12 mm), about 5 mm retraction (e.g., a radial spacing of about 7 mm), and about 2.5 mm retraction (e.g., a radial spacing of about 4.5 mm) from the outer circumference 74 and the noise levels are measured and are shown as the “10 mm retraction,” “5 mm retraction,” and “2.5 mm retraction” columns in FIGS. 12, and 13. Rotors having the typical vane member configuration (e.g., 92, 96, similar to FIG. 9), can be measured again for comparison in the absence of any retraction of one or both of the exterior and interior wall portions 76, 84, respectively of the vane member and are shown as the “original rotor” column in FIGS. 12 and 13. It is appreciated that for the purpose of this example, the 10 mm, the 5 mm, and the 2.5 mm cuts are in addition to the typical exterior radial spacing V_{OD} of d1 in the typical exterior vane configuration 92 (e.g., D1=d1+10 mm, 5 mm, or 2.5 mm, where d1 and d2 are generally about 2.0 mm and the retracted exterior radial spacing V_{OD} of D1 is generally about 12 mm, 7 mm and 4.5 mm, respectively). Without being bound by theory, it is contemplated that in utilizing a retracted vane configuration (e.g., in the interior portion 70 and/or the exterior portion 72 of the vane member), brake performance may be improved by reducing noise level by at least about 50%, preferably at least about 70%, and more preferably at least about 90% relative to a rotor without a retracted vane configuration.

More specifically, with reference to FIG. 12, several test examples are provided showing a “Max” noise level and a Noise Rating (AONR) for each respective example. The Max noise level is the largest noise level obtained for that example. The Noise Rating is a number based on the number of brake stops (e.g., number of brake-on positions) that obtained a brake noise at least about a predetermined reference sound pressure level (e.g., 70 dB) and the difference in excess of the reference sound pressure level relative to the total number of brake stops. The number of brake stops may be at least 1000 brake stops, though possibly less, and preferably at least about 2000 stops. It is appreciated that the larger the noise rating, the greater the occurrence of brake noise during a brake-on position.

FIG. 12 shows the Max noise level obtained in the respective examples is measured from about 90 dB to about 125 dB in the typical original rotors having the typical exterior and interior vane member configurations. The Max noise level obtained in the respective examples is measured from generally no squeal to about 85 dB in the rotors having the retracted exterior vane member configurations. The Noise Rating determined in the respective examples is measured from about 0.17 to about 140 in the typical original rotors having the typical exterior and interior vane member configurations. The Noise Rating determined in the respective examples is measured from about 0.0 to about 0.15 for retracted rotors having the retracted exterior vane member configuration.

Referring to FIG. 13, the Percentage of Occurrence (% Occurrence) is shown relative to the number of brake stops performed for typical original rotors and for retracted rotors. The frequency of brake noise occurrence obtained in the respective examples is measured from about 4.4% to about 44.4% in the typical original rotor having the typical exterior and interior vane member configurations. The frequency of brake noise occurrence obtained in the respective examples is measured from about 0.0% to about 4.0% in the rotors having the retracted exterior vane member configuration. Thus it is seen in a rotor with a retracted exterior vane configuration that brake noise occurrence can be improved (e.g., reduced) by at least about 1.1 times, by at least about 5 times, or even at least about 10 times relative to a typical rotor without a retracted exterior vane configuration. Optionally or as an alternative, it is contemplated that similar result may be achieved in vane members having the exterior retracted vane configuration 94, the interior retracted vane configuration 90, or a combination of both retracted vane configurations (with or without at least one groove feature).

It is appreciated that in the above examples with reference to FIGS. 12 and 13, only diver side front brake noise was documented as it was persistently nosier than the passenger side front brake. Furthermore, each tests was conducted using new production friction pads, new design cast brackets and new rotors (e.g., original and retracted).

Generally it is known and understood that the environment that the disc brake rotor is located within is sometimes referred to as a corner module for a vehicle. This corner module generally includes; a hub and bearing; a caliper assembly; and the rotor. A knuckle and or one or more suspension components (e.g. a strut or arm) may also be part of the corner module. The present invention thus also contemplates assemblies that include the present brake components in combination with other components as part of an assembly or corner module.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. The rotor hat 22 and the disc or plate 24 can be either a unitary structure or separate pieces that are assembled together. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A disc brake rotor, comprising:
a. a rotor hat;
b. a pair of spaced apart plates including:
i) a first plate including an outer wall portion and an inner wall portion that is attached with the rotor hat; and
ii) a second plate including an outer wall portion and an inner wall portion that defines an inner circumference;
iii) wherein at least one of the outer wall portions of the first and second plates define an outer circumference;
c. one or more vane members located between the first and second plates, the one or more vane members including:
i) an exterior wall portion inwardly retracted from the outer circumference by an exterior radial spacing to define a retracted exterior vane member configuration;
ii) an interior wall portion outwardly retracted from the inner circumference by an interior radial spacing; and
iii) wherein at least one of the exterior radial spacing and the interior radial spacing is a distance having a depth greater than about 5 mm.

2. A rotor according to claim 1, wherein the ratio of (i) the exterior radial spacing to the diameter of the rotor, (ii) the interior radial spacing to the diameter of the rotor, or (iii) both (i) and (ii) is from about 1:80 to about 1:10.

3. A rotor according to claim 1, wherein the exterior radial spacing is a distance having a depth greater than 10 mm.

4. A rotor according to claim 1, wherein at least one of the exterior radial spacing and the interior radial spacing is distance having a depth from about 7 to about 15 mm.

5. A rotor according to claim 4, wherein brake noise occurrence for a brake noise level greater than about 70 dB is reduced by at least about 1.1 times relative to a typical rotor without the retracted exterior vane member configuration.

6. A rotor according to claim 5, wherein both the exterior radial spacing and the interior radial spacing are a distance having a depth greater than about 5 mm.

7. A rotor according to claim 6, wherein the exterior radial spacing and the interior radial spacing are generally a distance having a depth that is the same or different.

8. A rotor according to claim 1, wherein at least one of the exterior wall portion and the interior wall portion is generally a flat surface or an arcuate surface.

9. A rotor according to claim 1, wherein at least one of the exterior wall portion and the interior wall portion include a peripheral wall, the peripheral wall being separated so as to define at least one groove having two opposing wall portions of equal thickness or of different thickness, the at least one groove has a profile relative to the peripheral wall including a portion that is characterized by a flat side wall, an arcuate side wall, a flat bottom, an arcuate bottom, a portion substantially resembling a U-shape, a portion substantially resembling a V-shape, or any combination thereof.

10. A disc brake rotor, comprising:
a. a rotor hat;
b. a pair of spaced apart plates including:
i) a first plate including an outer wall portion and an inner wall portion that is attached with the rotor hat; and
ii) a second plate including an outer wall portion and an inner wall portion that defines a inner circumference;
iii) wherein at least one of the outer wall portions of the first and second plates define an outer circumference;
c. a plurality of spaced apart vane members radially extending from an interior portion to an exterior portion of the rotor, the plurality of vane members located between the first and second plates, and including:
i) an exterior wall portion defining an exterior peripheral wall, the exterior wall portion being inwardly retracted from the outer circumference by an exterior radial spacing;
ii) an interior wall portion defining an interior peripheral wall, the interior wall portion being outwardly retracted from the inner circumference by an interior radial spacing; and
iii) wherein at least one of the exterior radial spacing and the interior radial spacing is a distance having a depth from about 7 to about 15 mm.

11. A rotor according to claim 10, wherein the ratio of (i) the exterior radial spacing to the diameter of the rotor, (ii) the interior radial spacing to the diameter of the rotor, or (iii) both (i) and (ii) is from about 1:80 to about 1:10.

12. A rotor according to claim 10, wherein the exterior radial spacing is a distance having a depth from about 10 about 15 mm and the interior radial spacing is a distance having a depth less than about 5 mm.

13. A rotor according to claim 11, wherein both the exterior radial spacing and the interior radial spacing are a distance having a depth from about 7 to about 15 mm.

14. A rotor according to claim 10, wherein brake noise occurrence for a brake noise level greater than about 70 dB is reduced by at least about 1.1 times relative to a typical rotor without the retracted exterior vane member configuration.

15. A rotor according to claim 10, wherein at least one of the exterior wall portion and the interior wall portion is generally a flat surface or an arcuate surface.

16. A rotor according to claim 10, wherein at least one of the exterior peripheral wall and the interior peripheral wall is separated so as to define at least one groove having two opposing wall portions of equal thickness or of different thickness.

17. A rotor according to claim 16, wherein the at least one groove has a profile relative to one of exterior and interior peripheral walls including a portion that is characterized by a flat side wall, an arcuate side wall, a flat bottom, an arcuate bottom, a portion substantially resembling a U-shape, a portion substantially resembling a V-shape, or any combination thereof.

18. A disc brake rotor, comprising:
a. a rotor hat;
b. a pair of spaced apart plates including:
i) a first plate including an outer wall portion and an inner wall portion that is attached with the rotor hat; and
ii) a second plate including an outer wall portion and an inner wall portion that defines a inner circumference;
iii) wherein at least one of the outer wall portions of the first and second plates define an outer circumference;
c. a plurality of spaced apart vane members radially extending from an interior portion to an exterior portion of the rotor, the plurality of vane members located between the first and second plates, and including:
i) an exterior wall portion defining an exterior peripheral wall, the exterior wall portion being inwardly retracted from the outer circumference by an exterior radial spacing;
ii) an interior wall portion defining an interior peripheral wall, the interior wall portion being outwardly retracted from the inner circumference by an interior radial spacing; and
iii) wherein the exterior radial spacing and the interior radial spacing are a distance having a depth from about 7 to about 15 mm; and
d. wherein brake noise occurrence for a brake noise level greater than about 70 dB is reduced by at least about 1.1 times relative to a typical rotor without the retracted exterior vane member configuration.

19. A rotor according to claim 18, wherein at least one of the exterior wall portion and the interior wall portion is generally a flat surface or an arcuate surface.

20. A rotor according to claim 18, wherein at least one of the exterior and interior peripheral walls is separated so as to define at least one groove having two opposing wall portions of equal thickness or of different thickness, the at least one groove having a profile relative to one of the exterior and interior peripheral walls including a portion that is characterized by at least two of a flat side wall, an arcuate side wall, a flat bottom, an arcuate bottom, a portion substantially resembling a U-shape, a portion substantially resembling a V-shape, or any combination thereof.
